(19) United States
(12) Patent Application Publication
(10) Pub. No.: US 2018/0016036 A1
(43) Pub. Date: Jan. 18, 2018

(54) METHOD AND SYSTEM FOR MEASURING THE ANGULAR VELOCITY OF A BODY ORBITING IN SPACE

(71) Applicant: POLITECNICO DI TORINO, Torino (IT)

(72) Inventors: Stefano MAURO, Torino (IT); Stefano PASTORELLI, Torino (IT); Tharek Manuel MOHTAR EIZAGA, Torino (IT); Gabriele BIONDI, Torino (IT); Massimo SORLI, Torino (IT)

(21) Appl. No.: 15/545,259

(22) PCT Filed: Jan. 19, 2016
(86) PCT No.: PCT/IB2016/050247

§ 371 Date: Jul. 20, 2017

(30) Foreign Application Priority Data
Jan. 20, 2015 (IT) TO2015A000043

(51) Int. Cl. B64G 3/00; G01P 3/38

(52) U.S. Cl. CPC B64G 3/00; G01P 3/38

(57) ABSTRACT

The invention relates to a method for measuring the angular velocity (\vec{ω}) of a body (2) orbiting, or in motion anyway, in space depending on the detection of the trajectory of a plurality (n) of feature points (Pi) to be observed of said body (2), said trajectory being detected on the basis of data acquired by at least one remote sensor (1); the invention relate also to the related system for measuring the angular velocity (\vec{ω}) of a body (2) orbiting, or in motion anyway, in space using such method and that comprises at least one remote sensor (1), it being possible for said at least one sensor (1) to be installed on board a spacecraft (3) or to be housed in a earth station (5).

The present invention has a preferred application for measuring the angular velocity in fields such as for recovering and de-orbiting space debris.

### TECHNICAL FIELD

The present invention relates to space sector, and specifically, to the identification of objects in orbit in space such to capture them and then to disintegrate or transfer them to another orbit.

More specifically, the present invention relates to a method, and related system, for measuring the angular velocity of one or more objects orbiting in space.

The invention has a preferred and advantageous application when employed for recovering and de-orbiting space debris and also for intercepting and then destroying or migrating asteroids, potentially colliding with Earth, into a controlled orbit.

### PRIOR ART

There are two types of space debris (also known as orbital debris, space junk or space waste): natural and artificial types; natural space debris are composed of small fragments of material from comets and asteroids while artificial space debris are all the non-functional artificial objects present in space, usually in orbit around Earth. The first piece of artificial space debris was created at the beginning of the space era, on Oct. 4, 1957, when the last stage of the rocket that launched Sputnik-1 remained in orbit.

In 2013 the total number of catalogued objects was about 17,000, of which 9,500 were debris fragments, 3,500 were active satellites, 2,000 were propulsion rockets and finally inactive satellites were the same number.

On average, every day an object catalogued to be more than 10 cm in diameter falls on Earth, and therefore the fundamental problem is identifying said objects in orbit also in connection with the prevention of risks related to the so called NEOs (Near Earth Objects).

The re-entry risk is not only due to the mechanical impact, but also to chemical or radiological environmental contamination; moreover space debris can compromise the operation of active satellites damaging them by collision or reducing their performances by being deposited on surfaces of optical systems, degrading solar panels and antennas, thus reducing their transmitting ability and causing interferences with signals.

Therefore for more than half a century the problem of capturing space debris, both natural and artificial ones, has been faced in order to destroy or deviate them from their orbit into a controlled orbit and it is known that such operations rely on the possibility of determining a physical quantity that generally cannot be directly measured, such as for example the position of the center of mass, the angular velocity, inertia tensor or mass.

In order to solve the technical problem set forth above, the same Applicant has found the solution described in the Italian patent application n. TO2014A000550, that relates to a system for visually identifying the center of mass of an object in orbit in the space and related process of physical and mechanical characterization of the identified object.

The solution mentioned above provides in particular a visual identification system comprising at least one remote sensor placed on board a station adapted to detect space coordinates of certain points belonging to an identified object with respect to a reference system; said visual identification system further comprises first means for acquiring data related to positions taken over time by said given points for reconstructing the trajectory followed by said given points and second means for determining the instantaneous rotation axes of the identified object associated with such trajectory and a segment perpendicular to each pair of the instantaneous rotation axes in a sequence as well as for locating the mean point of such segment; said visual identification system further comprises third means for computing a discrete function of the length of such segments, for computing an envelope curve of the local maxima of such discrete function and for determining the minimum of such envelope curve for locating the barycenter of the identified object.

However the above invention does not provide to measure the angular velocity of a body orbiting in space.

The fact of determining the angular velocity of a body in orbit, called also as “target” both in the reference technical field and herein below, is a well-known problem within the control of aerospace systems: there are several scientific articles about the issue and it is also possible to find the presence of different methods and systems for solving the problem that are the subject matter of patent applications.

However the methods and systems present in literature rely all on the presence of standard instruments on board spacecraft; particularly in all the cases at least the use of “star trackers” is required, that is devices measuring the attitude of the target, represented by a quaternion with unit Euclidean norm, with respect to the position of suitably catalogued fixed stars. All the patented methods, moreover, use suitable observers for estimating the target state that, generally, can comprise angular velocity thereof.

The theoretical bases of the known methods can be found, for example, in Lefferts et al. [1], describing a general method based on an extended Kalman Filter (EKF) for estimating the attitude of a controlled satellite, starting from attitude measurements from star trackers and angular velocity measurements from gyroscopes; the study by Atzor et al. [2] as an alternative to EKF describes additional approximate versions of the Kalman filter for estimating the angular velocity of a satellite starting only from delayed attitude measurements.

The publication by Singla et al. [3] in 2002 disclosed a possible real application of EKF in GIFTS (Geostationary Imaging Fourier Transform Spectroscopy) space mission for determining the attitude of a satellite equipped with gyroscopes and star trackers, suggesting also possible on-orbit calibration methods therefor; a further publication of the following year by Singla et al. [4] disclosed another method for estimating the attitude of a satellite and its angular velocity still based on EKF but suitable in case the use of gyroscopes is not provided to face the need of reducing sensors on board the satellites.

The disadvantages of the methods and systems described above substantially are the fact that for being used they need operating sensors to be on board the satellite.

Moreover it is necessary for the on-board measurements to be carried out at regular time intervals with a constant duration.

The methods and the systems of patent applications, discussed below in details, are mainly focused on an appropriate use of star trackers in order to obtain as the input of Kalman filter optimal attitude measurements in terms of accuracy and frequency of acquisition.

In particular the US patent application n. 2005/0071055 to Yoshikawa et al. (see reference [5]) describes a system based on several star video cameras that evaluates different possible attitude candidates in relation to the position of some fixed stars associated with different possible catalogued stars; the various candidate measurements obtained with a given delay with respect to the current condition of the satellite are projected forward over time by the Kalman filter and are compared with new candidates. The solution according to such document allows the attitude and the angular velocity of the satellite to be determined over time; however such solution cannot be applied independently of the use of said star video cameras placed on board the spacecraft.

The US patent application n. 2004/0098177 to Needelman et al. (see reference [6]) describes a method, and related system, for determining the angular velocity and attitude of a satellite by using different acquisitions of star trackers by an on-board computer; the control system processes the acquisitions and it provides the future signals that can be acquired by the star trackers, thus artificially expanding their field of view and facilitating the recognition of the observed stars.

The US patent application n. 2005/0071055, still to Needelman et al., (see reference [7]) is an improvement of said method and system; in such document different equations have been added, which, by knowing residuals between observed star positions and predicted positions, calculate more accurate estimates of the attitude and angular velocity of the satellite.

However the solutions described in the above applications to Needelman et al. are not able to estimate attitude and angular velocity of the satellite if the on-board instruments are subjected to any malfunctions.

The US patent application n. 2011/007167 to Katake et al., (see reference [8]) discloses a method and a system for estimating the angular velocity of satellites on the basis of an advanced EKF and of star trackers with acquisition rates higher than 100 Hz; the solution described in such document, even if facing the technical problem of measuring the angular velocity of a body orbiting in space, is not suitable for measuring it if such body is completely passive, that is with no “star trackers”. All the described solutions listed up to now are different from each other only for some small technical details; however they are all valid and effective in calculating the angular velocity of a satellite provided with on-board sensors.

Finally the Chinese patent application n. CN101706512 to Chen et al., (see reference [9]) describes a method, and related system, for estimating the angular velocity of satellites by a Kalman filter by using the combination of satellite orientation measurements and measurements of angular momentum; however such solution requires further measurements in addition to the orientation one and therefore it is less effective than the solutions mentioned above.

In literature signal compression algorithms are also known; they are useful for representing extended data time series in a compact and synthetic form. They are inspired by the Basis Pursuit (BP) concept, whose theoretical grounds can be appreciated, for example, in Tropp [10]; however such study does not point out for example how BP inspired techniques can be used not only for signal compression, but also for reconstructing corrupt samples of a given signal.

Algorithms inspired by the BP approach set forth above have been applied in several fields, and particularly they have found a great success in the field of reconstruction of distorted images; an important example is provided in Afonso [11] by the SALSA algorithm (Split Augmented Lagrangian Shrinkage Algorithm, iterative algorithm based on the augmented Lagrangian function and on variable splitting). The method has been used in the present invention, besides treating the attitude measurements, also for de-noising the angular velocity estimated by Kalman filter, thus avoiding the use of LTI (Linear Time-Invariant) filters that are usually used for removing high frequency noise from a given signal, but that, with the measurement of the angular velocity of a body orbiting in space are not effective.

Therefore there is the unsatisfied need of carrying out the estimate of the attitude and angular velocity conditions of a “dead” body orbiting in space, for example a satellite with no instrument on board for measuring said attitude or said angular velocity or whose sensors are damaged and unusable.

Moreover there is the unsatisfied need of carrying out the estimate of said attitude and angular velocity conditions indirectly by means of remote instruments able to acquire the position of few feature points of the outer surface of the “dead” body in orbit.

The method and system according to the present invention provide, therefore in a completely new and original manner, to estimate the attitude and angular velocity conditions of any “dead” body orbiting in space, for example a satellite with no instrument on board for measuring said attitude or said angular velocity or whose sensors are damaged and unusable.

The method and system according to the present invention provide also such measurements to be obtained indirectly by means of remote instruments able to acquire the position of few feature points of the outer surface of the satellite. Such measurements can be possibly affected by errors and not be acquired with a constant rate.

Briefly, up to now, as known by the applicant, solutions allowing the angular velocity of a body in orbit to be measured without requiring availability of sensors on board and with no mechanical interaction therewith are not known; therefore the Applicant by the method and system of the present invention desires to remedy such lack.

### OBJECTS AND SUMMARY OF THE INVENTION

It is the object of the present invention to overcome the drawbacks of prior art related to defining the angular velocity of a body orbiting in space.

More precisely,the object of the present invention is the determination of the angular velocity of a “dead” body orbiting in space, for example a satellite with no instruments on board for measuring said angular velocity or whose sensors are damaged and unusable.

In particular the object of the present invention is to provide a method for measuring the angular velocity of one or more objects in orbit in space, also having no sensors or with damaged sensors.

A further object of the present invention then is to provide a system for measuring the angular velocity of one or more objects in orbit in space, also having no sensors or with damaged sensors.

Said and further objects and advantages of the invention, as will be clear from the description below, are achieved by a method for measuring the angular velocity of at least one object in orbit in space such as the one according to claim 1.

Moreover the above and further objects and advantages of the invention are achieved by a system for measuring the angular velocity of at least one object in orbit in space such as the one according to claim 8.

Preferred embodiments and variants of the method and system of the present invention are the subject matter of the dependent claims; in particular in a first embodiment, the method and system according to the invention provide a remote sensor installed on board a spacecraft, while in a second embodiment, the method and system according to the invention provide a remote sensor housed in a ground station.

It is understood that all the annexed claims are an integral part of the present description and that each one of the technical characteristics claimed therein is possibly independent and usable autonomously from the other aspects of the invention.

It is immediately clear that several changes (for example about shape, dimension, arrangements and parts with equivalent functionalities) can be made to what described without departing from the scope of protection of the invention as claimed in the annexed claims.

Advantageously the technical solution according to the present invention combining algorithms inspired by the Basis Pursuit (BP) concept and working on partial attitude measurements with the application of Kalman filter intended to estimate the angular velocity allows:

the angular velocity of a body in orbit to be accurately defined without the use of measurements taken by instruments placed on board the body and without carrying out any action intended to disturb the motion of the target,

the measurement of the angular velocity of a body in motion in space to be taken by only observing the motion of some points thereof,

the calculation method to be unified with the use of remote measurement devices,

space debris to be recovered and/or de-orbited, and

missions to be planned for protecting Earth against impact with space bodies such as asteroids on a collision course (NEOs) within the Horizon 2020 programme.

Further advantageous characteristics will be more clear from the following description of preferred but not exclusive embodiments, provided merely by way of example and not as a limitation.

### BRIEF DESCRIPTION OF THE DRAWINGS

The present invention will be described below by some preferred embodiments, provided by way of example and not as a limitation, with reference to the annexed drawings. These drawings show different aspects and examples of the present invention and, where appropriate, like structures, components, materials and/or elements in different figures are denoted by like reference numerals.

FIG. 1 is a flow chart showing the steps of the method for measuring the angular velocity of a body orbiting in space according to the present invention;

FIG. 2 is a schematic view of a first embodiment of the system for measuring the angular velocity of a body orbiting in space according to the present invention;

FIG. 3 is a schematic view of a second embodiment of the system for measuring the angular velocity of a body orbiting in space according to the present invention;

FIG. 4 is a graphical representation of one embodiment of the body orbiting in space, of its observed points and of a possible reference triad fixed to said orbiting body, according to the present invention;

FIG. 5 is a graphical representation of an alternative embodiment of the body orbiting in space and of the positions taken by five of its points observed over time with respect to an observer-fixed reference frame, according to the present invention;

FIG. 6 is a graphical representation of the acquired data related to Euclidean coordinates of the observed point P1 of FIG. 5 with respect to an observer-fixed reference frame, according to the present invention;

FIG. 7 is a graphical representation of quaternions q*(tk), describing the orientation of a particular selected triad of axes A*, with respect to an inertial frame, said quaternions q*(tk) being evaluated according to step 107 of FIG. 1 and being dependent on the quaternions qj(tk) evaluated at step 106 of FIG. 1;

FIG. 8 is a graphical representation, useful for estimating the angular velocity \vec{ω}, of the quaternions q*(tk) describing the orientation of the triad of axes A*, in the moments when less than three points Pi are visible to determine the attitude over time of a body 2 orbiting in space according to step 108 of FIG. 1;

FIG. 9 is a graphical representation of a first estimate of the angular velocity \vec{ω} of a body 2 orbiting in space depending on the derivative \dot{q}*(tₖ) according to step 112 of FIG. 1; and

FIG. 10 is a graphical representation, useful for pointing out the goodness of the result of the method and system by comparing with the real quantity, of the final measurement of a component of the angular velocity \vec{ω} of a body 2 orbiting in space, obtained by a filtering algorithm according to step 113 of FIG. 1.

### DETAILED DESCRIPTION OF THE INVENTION

While the invention is susceptible of various modifications and alternative forms, some preferred embodiments are shown in the drawings and will be described below in detail.

It should be understood, however, that there is no intention to limit the invention to the specific embodiment disclosed, but, on the contrary, the intention of the invention is to cover all modifications, alternative constructions and equivalents falling within the scope of the invention as defined in the claims.

Therefore, in the description below, the use of “for example”, “etc.”, “or” indicates non-exclusive alternatives without limitation unless otherwise defined; the use of “also” means “among which, but not limited to”, unless otherwise defined; the use of “include/comprise” means “include/comprise, but not limited to,” unless otherwise defined.

The method and system of the present invention are based on the innovative concept of combining algorithms inspired by the Basis Pursuit (BP) concept working on partial attitude measurements, with the application of a Kalman filter intended to estimate the angular velocity of a body orbiting in space.

In the present description, the term “body orbiting in space” means any body or object in orbit, or anyway in motion, in space; more precisely the term “body orbiting in space” means any rigid body subjected only to gravitational fields or possibly disturbed by external actions, possibly non-conservative ones, that generate on the body accelerations considerably lower than those generated by said gravitational fields.

In order to avoid any interpretative misunderstanding, we specify herein that the motion of bodies in space is due to the presence of gravitational fields, that is the presence of considerable masses near the body (for example Earth exerts a gravitational attraction on satellites); however there are also other forces that can be exerted by the space environment (for example also at many kilometers from the earth surface there can be a very low amount of air exerting friction on the satellite), but such forces however have to be much lower than the force of gravity.

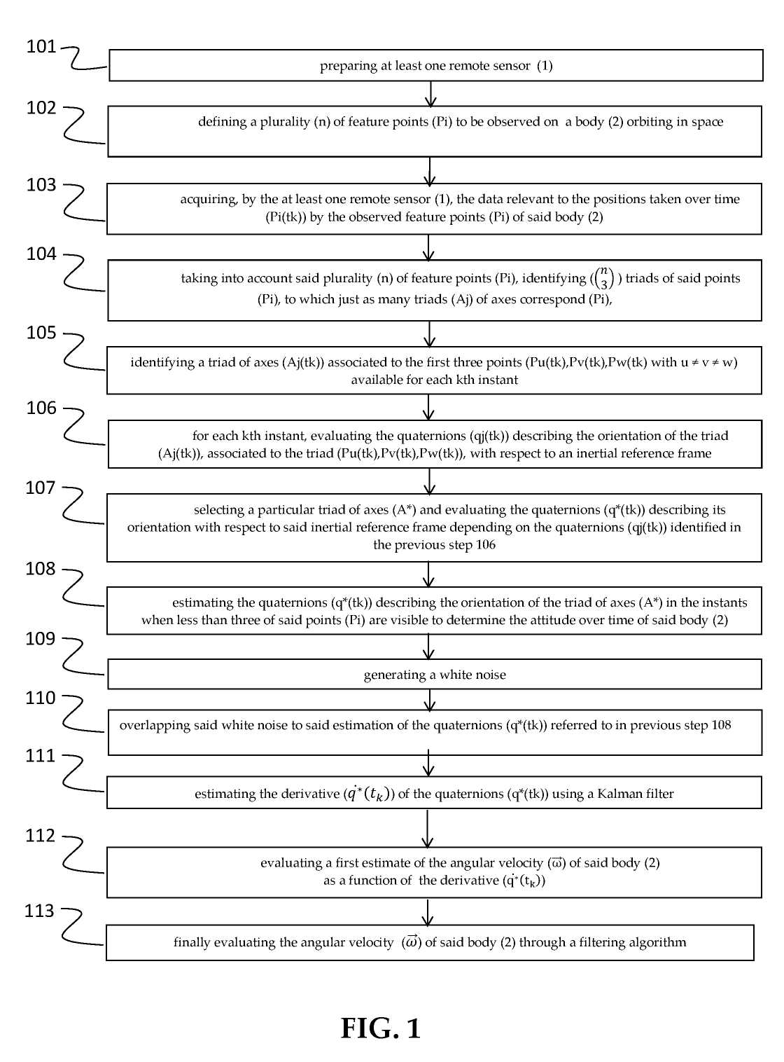

With reference to FIG. 1, the method for measuring the angular velocity \vec{ω} of a body 2 orbiting in space according to the present invention, comprises the steps of:
a. preparing at least one remote sensor 1 (step 101);
b. defining a plurality n of feature points Pi to be observed of said body 2 orbiting in space (step 102);
c. acquiring, by the at least one remote sensor 1, the data relevant to the positions taken over time Pi(tk) by the observed feature points Pi of said body 2 (step 103);
d. taking into account said plurality n of feature points Pi, identifying (n/3) triads of said points Pi, to which just as many triads Aj of axes correspond (step 104);
e. identifying a triad of axes Aj(tk) associated to the first three points Pu(tk),Pv(tk),Pw(tk) with u≠v≠w available for each k^{th} instant (step 105);
f. for each k^{th} instant, evaluating the quaternions qj(tk) describing the orientation of the triad Aj(tk), associated to the triad Pu(tk),Pv(tk),Pw(tk), with respect to an inertial reference frame (step 106);
g. selecting a particular triad of axes A* and evaluating the quaternions q*(tk) describing its orientation with respect to said inertial reference frame depending on the quaternions qj(tk) identified in the previous step 106 (step 107);
h. estimating the quaternions q*(tk) describing the orientation of the triad of axes A* in the instants when less than three of said points Pi are visible to determine the attitude over time of said body 2 (step 108);
i. generating a white noise (step 109);
j. overlapping said white noise to said estimation of the quaternions q*(tk) referred to in the previous step 108 (step 110);
k. estimating the derivative \dot{q}*(tₖ) of the quaternions q*(tk) using a Kalman filter (step 111);
l. evaluating a first estimate of the angular velocity \vec{ω} of said body 2 depending on the derivative \dot{q}*(tₖ) (step 112); and
m. finally evaluating the angular velocity \vec{ω} of said body 2 through a filtering algorithm (step 113).

Preferably said at least one remote sensor 1 is a pair of digital cameras.

Said plurality n has to be at least a number equal to three not aligned feature points Pi, while there are no limits about the maximum value of said number.

Preferably said feature points Pi to be observed of said body 2 are represented by points belonging to corners or appendages or antennas of the body.

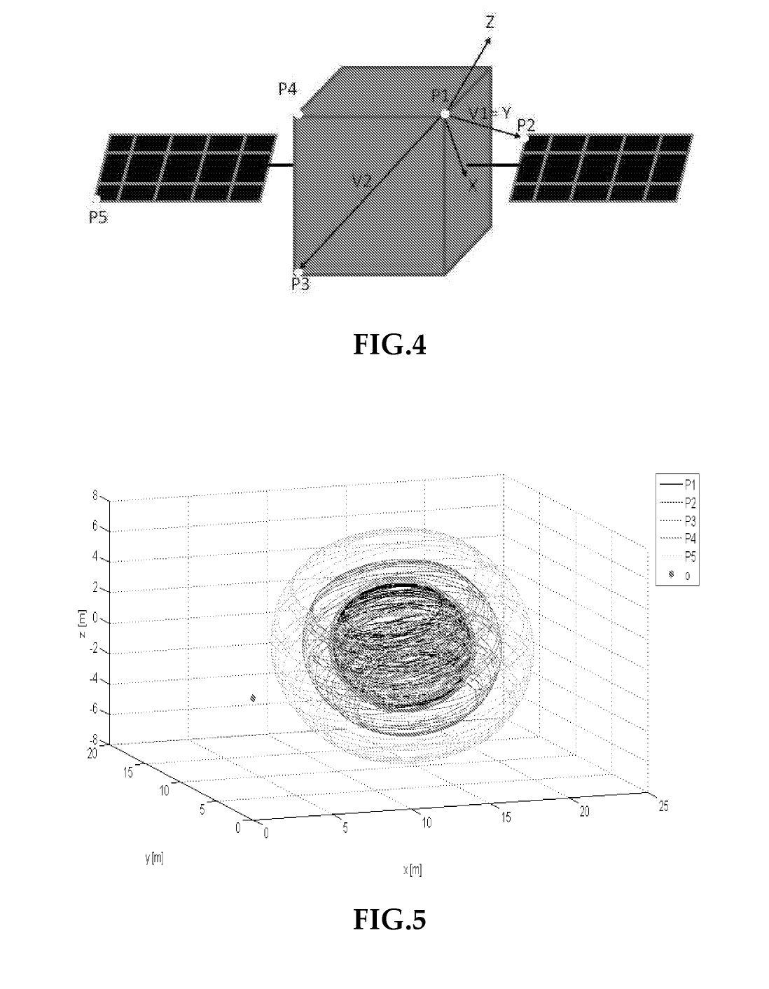

One embodiment, shown in FIG. 4, provides said plurality to be a number equal to five feature points; although it is always preferable for such number to be higher.

Said FIG. 4 shows the five feature points of a hypothetic and possible body 2, placed at the corners.

In one embodiment, the method according to the present invention provides the geometrical configuration of said body 2 to be known, and preferably the relative position of said feature points Pi to be observed of the said body 2 to be known.

In one embodiment the method according to the present invention provides the geometrical configuration of said body 2 not to be known and the relative position of said feature points Pi to be observed of said body 2 to be determined on the basis that, being known the coordinates of four different points in a time instant, their mutual positions, which are invariant, are determinable and of the fact that, when one of said feature points Pi is not visible in other time instants, its position can be identified by knowing that of said invariant mutual positions.

Preferably said positions taken over time Pi(tk) by said observed feature points Pi of said body 2 can be represented by triads of Euclidean coordinates, that is by a three-dimensional vector according to a reference frame fixed to said sensor 1.

In one embodiment, shown in FIG. 5, said positions taken over time Pi(tk) by said observed feature points Pi of said body 2 are samples related to continuous trajectories of said points around the center of mass of said body 2.

Said FIG. 5 is a graph showing the trajectories in space of five possible points of a hypothetic body 2, different from the one represented in the previous FIG. 4.

Preferably the acquisition by said at least one remote sensor 1 of said data related to said positions occurs at a suitable sampling rate, by any acquisition chain, preferably composed of said sensor 1, any acquisition card and a computer.

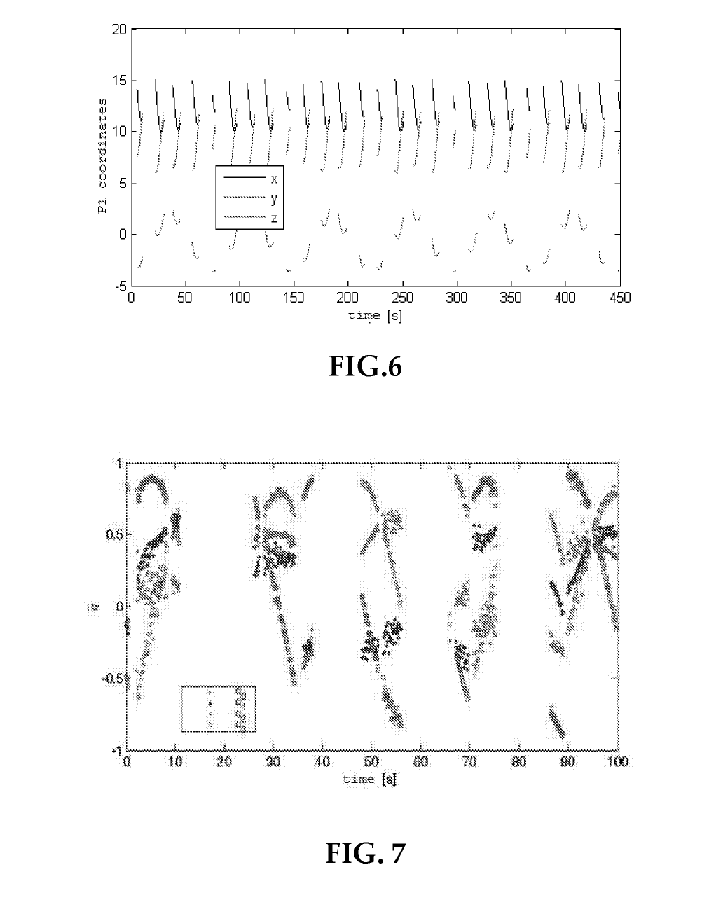

In one embodiment, shown in FIG. 6, the method according to the present invention provides the acquisition of data by said at least one remote sensor 1 to occur in a discontinuous manner, due to the presence of non-visibility periods of at least one of said feature points Pi of said body 2.

Said FIG. 6 shows a possible graphical representation of the data acquired by the sensor 1 with reference to the observation of point P1 of FIG. 5.

Preferably the identifying of said (n/3) triads of said feature points Pi is based on the fact that given three of said feature points Pi (for example P1, P2 and P3), it is possible to uniquely determine two vectors (for example V1 and V2) not perpendicular with each other (for example the vector P2-P1 and the vector P3-P1). The cross product of said two vectors generates a vector perpendicular to said two vectors. The cross product of this last perpendicular vector and one of said two vectors (for example P2-P1) generates a third perpendicular vector, that once united to the other two perpendicular vectors is one of said corresponding triads Aj of axes. FIG. 4 shows a possible implementation of said technique.

Preferably, the identifying of one of said triads of axes Aj(tk) associated to the first three points Pu(tk),Pv(tk),Pw(tk), with u≠v≠w, available for each k-th instant occurs according to said technique.

Preferably, said first three points Pu(tk),Pv(tk),Pw(tk), with u≠v≠w, available for each k-th instant are the first three points available at instant tk; that is to say, if for example at instant t1 the positions of the points P1, P4, P5 and P6 are available to the sensor, the points Pu, Pv and Pw will be P1, P4, and P5 while at instant t2 the situation may be different, and in particular, the points Pu, Pv and Pw may be for example P4, P5 and P6.

Preferably said indexes u, v, w and j are of general type and change instant by instant.

The maximum value of u, v, and w is equal to the number of points, therefore since the available number of points is not predetermined in any manner (that is since a maximum number of points is not provided), u, v, and w can take values ranging from 1 to infinite.

The maximum value of j obviously will be

$$( \begin{matrix}n \\ 3\end{matrix} ) .$$

For example, if the observed points are 5, such as shown in FIG. 4, u can take values ranging from 1 to 5 (the same for v and w) and j can take values ranging from 1 to 10 (binomial of 5 choose 3).

It is specified that said k-th instant is any one of infinite instants.

Preferably said inertial reference frame is represented by an equatorial coordinate system with axis X facing the vernal equinox point.

Preferably, the selection of a particular triad of axes A* among the several Aj and the valuation of the quaternions q*(tk) describing its orientation with respect to said inertial reference frame are based on the most recurrent value of j in time instants tk. It has to be specified that in order to evaluate the orientation of the triad of axes A*, and therefore the quaternions q*(tk) describing such orientation with respect to the said inertial reference frame, it will be necessary to know the orientation of said reference frame fixed to the sensor 1, the trajectories of the n points Pi in time instants tk being expressed with respect to it.

Such hypothesis is completely consistent with the fact that the sensor 1 is placed on a spacecraft 3 completely controlled from Earth, or housed in an earth station 5.

In one embodiment, the characteristics of the quaternions q*(tk) describing the orientation of A*, are visible in FIG. 7

Preferably, the estimation of the quaternions q*(tk) describing the orientation of the triad of axes A* in the moments when less than three of said feature points Pi are visible occurs by recovering the missing samples based on SALSA algorithm. Starting from partial data of the quaternions q*(tk), such as in FIG. 7, according to a particular embodiment, m parts are considered as available. Since an intrinsic property of quaternions provides that two equal quaternions of opposite sign represent the same orientation of said triad A*, there will be a plurality of equivalent signals of quaternions q*(tk). In particular said plurality will be 2^{m-1} equivalent signals of quaternions, as the sign of the first of such parts has been previously fixed as one desires. The SALSA algorithm allows the missing sections to be estimated by searching for a matching with the available sections. However when patching together the 2^{m-1} equivalent signals, 2^{m-1} recovered signals will be obtained, but only one recovered signal will match a valid quaternion. In order to recognize which of such 2^{m-1} recovered signals is the valid one it is necessary to evaluate the frequency contents of the reconstructed signal. The one containing less considerable frequency contributions, will be the searched recovered signal.

The value of m has to be at minimum equal to two, but preferably it is equal to five, since, if m is higher, more computational resources will be required due to the exponential growth of the number of said equivalent signals of quaternions. On the other side if m is lower, it is possible for said algorithm to generate inconsistent results due to lack of available input data. Generally the number of available parts is well higher than five. Due to such reason it is preferred to make the recovery of the missing samples by considering five sections at a time.

Preferably said white noise is characterized by a suitable variance related to the maximum value that can be taken by the components of the quaternions q*(tk), that is 1; said white noise is generated by an algorithm generating normally distributed pseudo-random numbers.

Preferably the overlapping of said white noise on said quaternions q*(tk) occurs by algebraic sum.

The reason for such overlapping is based on the fact that the result thereof is the set of input measurements of a Kalman filter for estimating their derivatives. One of the hypothesis for which the filter optimality is guaranteed is that the entering measurements are affected by white noise. The strength of the Kalman filter however allows an acceptable estimation of the searched quantities also when the noise on the entering measurements is not strictly white.

Consistently with what said above, therefore, said overlapping is performed to promote the following step estimating the derivatives of the quaternions q*(tk) by the Kalman filter.

Preferably, said Kalman filter used for estimating the derivative \dot{q}*(tₖ) of quaternions q*(tk) is based on the following state equation:

$$[ \begin{matrix}{q}^{†} ( {t}_{k} ) \\ {\dot{q}}^{†} ( {t}_{k} ) \\ {\ddot{q}}^{†} ( {t}_{k} )\end{matrix} ] = [ \begin{matrix}I & dt I & \frac{1}{2} {dt}^{2} I \\ 0 & I & dt I \\ 0 & 0 & I\end{matrix} ] [ \begin{matrix}{q}^{†} ( {t}_{k - 1} ) \\ {\dot{q}}^{†} ( {t}_{k - 1} ) \\ {\ddot{q}}^{†} ( {t}_{k - 1} )\end{matrix} ] + {w}_{k}$$

and the following measurement equations:

$$q * ( {t}_{k} ) = [ \begin{matrix}I & 0 & 0 ]\end{matrix} [ \begin{matrix}{q}^{†} ( {t}_{k} ) \\ {\dot{q}}^{†} ( {t}_{k} ) \\ {\ddot{q}}^{†} ( {t}_{k} )\end{matrix} ] + {v}_{k}$$

Where I is a four dimension identity matrix, dt is tₖ−tₖ₋₁, q^{†}(tₖ) is the estimation of the real quaternion starting from the measurement q*(tₖ). wₖ and vₖ are the errors respectively associated to the model describing the time evolution of the state and to the measurement.

Preferably said filtering algorithm used for the final evaluation of the angular velocity \vec{ω} of said body 2 is based on the Basis Pursuit Denoising approach, solving a minimum search problem; more preferably the minimum search problem is solved by applying the SALSA algorithm.

It is completely clear for the person skilled in the art that the minimum search problem can be solved by any other algorithm suitable for the object of the present invention.

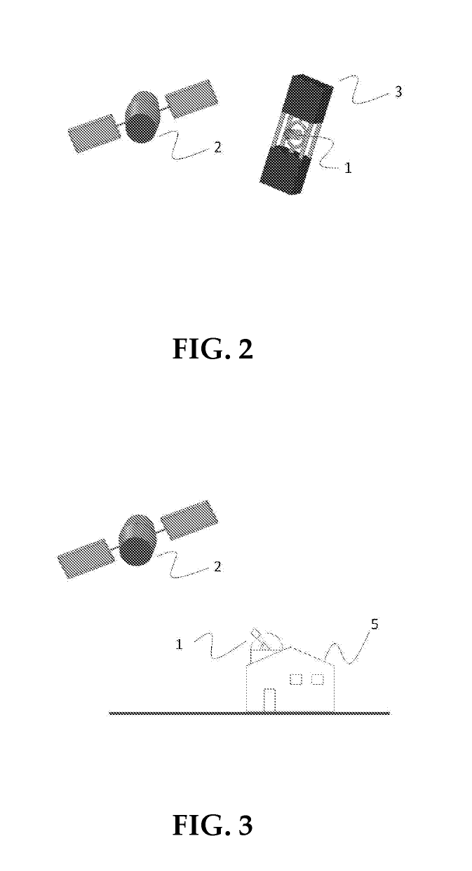

The method according to a first embodiment of the present invention provides said at least one remote sensor 1 to be installed on board a spacecraft 3 in motion in an orbit near to the one of said body 2, such as shown in FIG. 2 that will be described better below.

The method according to a second embodiment of the present invention provides said at least one remote sensor 1 to be housed in a ground station 5, such as shown in FIG. 3, that will be described better below.

The method according to the present invention is described below more in details and specifically with reference to one example, that has to be intended as illustrative but not as a limitation of the present invention; the following example has been developed on the basis of the data of the motion of a body orbiting in space, and precisely of a satellite, obtained by a simulation environment.

### EXAMPLE

Measurement of the angular velocity of a body 2 orbiting in space by means of a remote sensor 1 installed on board a spacecraft 3.

The body 2 orbiting in space has five feature points whose Euclidean coordinates are listed with reference to a principal central inertial reference frame:

| | |
|---|---|
| P1 | [4.00 0.00 0.00]m |
| P2 | [−5.71 0.00 −0.81]m |
| P3 | [−3.91 0.00 1.42]m |
| P4 | [−3.97 1.02 −1.02]m |
| P5 | [−7.61 0.00 0.00]m |

The orbit of said body 2 orbiting in space is defined by the following ephemerides:

| | |
|---|---|
| e | 0.55 |
| i | 6.93° |
| ω | 146.40° |
| Ω | 132.20° |
| h | 544.00 km |
| θ₀ | 349.90° |

Where e is eccentricity, i orbit inclination, ω the argument of perigee, Ω is the longitude of the ascending node, h is height at perigee and θ₀ is the true anomaly at instant t0.

The initial velocity of the body expressed with respect to the b frame is:

^{b}\vec{ω}₀=[0.17 0.01 −0.29]rad/s

The principal moments of inertia of said body 2 are:

^{b}I=[22435 18430 13420]k_{g} m²

The body 3, on which the sensor 1 is placed, is controlled such that the center of mass of the body 2 is at a constant distance from the origin of the reference frame fixed to the sensor 1 (frame c). In particular the coordinates of the point of the center of mass of the body 2 with respect to the c frame are [10 14 0]m.

From the simulation of the motion of these bodies it results that the trajectories taken by the feature points, according to frame c, are those shown in FIG. 5.

By the sensor 1 the five feature points are detected within their visibility intervals. With reference to P1, in FIG. 6, it is possible to appreciate the Euclidean coordinates of said points in said intervals, with respect to c frame.

The quaternions associated to the maximum recurrence triad in a time window (the one created by using the points P2, P4 and P5), describing the orientation of said triad with respect to an inertial frame are shown in FIG. 7.

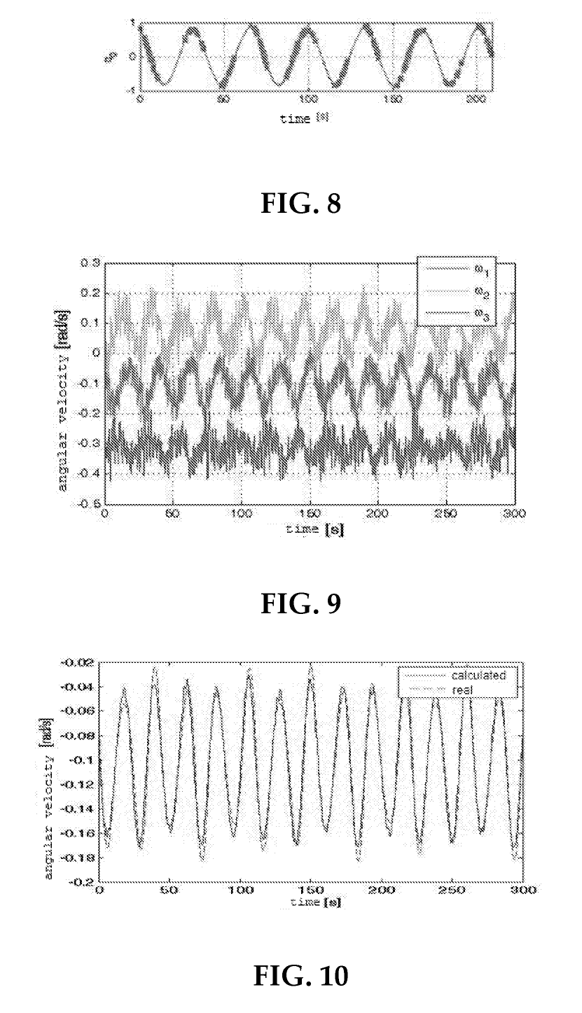

By applying the SALSA algorithm on the parts of the available quaternions a recovery is obtained as the one shown in FIG. 8.

The use of the Kalman filter, having the recovered orientation quaternions as input, overlapped on a white noise with a standard deviation equal to 0.1, that is 10% of the maximum value that can be taken by a single component (that is 1), leads to the first estimation of the angular velocity, one representation thereof being shown in FIG. 9. Finally the filtering of the first estimate via SALSA generates the final evaluation of the angular velocity of the body 2 orbiting in space. The representation of the evaluation is offered in FIG. 10, together with the real angular velocity of the body 2 orbiting in space. As it can be noted in FIG. 10 the maximum error is equal to 0.02 rad/s while mean error is 0.0044 rad/s.

Now with reference to FIGS. 2 and 3, it is noted that a system for measuring the angular velocity \vec{ω} of a body 2 orbiting in space comprises:
at least one remote sensor 1 for the acquisition of the data relevant to the positions taken over time Pi(tk) by a plurality n of feature points Pi to be observed of said body 2;
taking into account said plurality n of feature points Pi, first means for the identification of

$$( \begin{matrix}n \\ 3\end{matrix} )$$

triads of said points Pi, to which just as many triads Aj of axes correspond;
second means for the identification of a triad of axes Aj(tk) associated to the first three points Pu(tk),Pv(tk),Pw(tk) with u≠v≠w available for each k^{th} instant;
third means for the evaluation, for each k^{th} instant, of the quaternions qj(tk) describing the orientation of the triad Aj(tk), associated to the triad Pu(tk),Pv(tk),Pw(tk), with respect to an inertial reference frame;
fourth means for the selection of a particular triad of axes A* and the evaluation of the quaternions (q*(tk) describing its orientation with respect to said inertial reference frame depending on said quaternions qj(tk);
fifth means for the estimation of the quaternions q*(tk) describing the orientation of the triad of axes A* in the moments when less than three of said points Pi are visible to determine the attitude over time of said body 2;
sixth means for the generation of a white noise;
seventh means for the overlap of said white noise on said estimation of said quaternions q*(tk);
eighth means for the estimation of the derivative \dot{q}*(tₖ) of the quaternions q*(tk) using a Kalman filter;
ninth means for the evaluation of a first estimate of the angular velocity \vec{ω} of said body 2 depending on the derivative \dot{q}*(tₖ); and
tenth means for the final evaluation of the angular velocity \vec{ω} of said body 2 through a filtering algorithm.

Such as shown in FIG. 2, the system according to a first embodiment of the present invention provides said at least one remote sensor 1 to be installed on board a spacecraft 3 intended to track the body 2 orbiting in space.

Such as shown in FIG. 3, the system according to a second embodiment of the present invention provides said at least one remote sensor 1 to be housed in a ground station 5.

Preferably said at least one remote sensor 1 is a pair of digital cameras.

Preferably said first, second, third, fourth, fifth, sixth, seventh, eighth, ninth and tenth means in turn comprise algorithms intended to implement the steps 104 to 113 respectively as described above in details.

Therefore it is understood how the method and system according to the present invention allow the angular velocity of a body orbiting in space to be measured without requiring the availability of sensors on board and any mechanical interaction therewith.

Now refer to FIGS. 7 to 10 in order to show the application of the method and system according to the present invention for recovering and de-orbiting space debris.

Here we desire to specify that the graphs shown in said figures are examples showing some steps of the described method and are associated to debris to be identified having specific characteristics; it is clear that the curves will change depending on the different characteristics of different debris to be identified. Specifically, the orbiting body taken into account is the same body 2 considered in the example shown above with reference to the method according to the present invention.

With reference to FIG. 7 that shows a graph of step 107 of the method according to the present invention as shown in FIG. 1, it shows an example of the evolution over time of the four components of the quaternions q*(tk) depending on the quaternions qj(tk) and describing the orientation of the triad of axes A*; in particular, the abscissa shows time (unit of measure: seconds) while ordinate shows quaternions (dimensionless).

It is important to note that, since the quaternions give information about the body attitude, each component is subjected to a noise overlapped on the expected signal that depends on the error with which the data about the positions of points Pi are acquired in step 103 of the method according to the present invention such as shown in FIG. 1.

Then it has to be noted that in instants of time tk wherein less than three points Pi are visible to the remote sensor 1 it is not possible to determine the quaternion qj(tk) and therefore the quaternion q*(tk), therefore the graph does not show any value at said instants.

With reference to FIG. 8 showing a graph of step 108 of the method according to the present invention such as shown in FIG. 1, it shows the first of the components of the quaternion q*(tk) (referred to as component 0) estimated in non-visibility moments of at least three Pi; the small crosses identify the data available from the previous step 107 of the method according to the present invention such as shown in FIG. 1, while the continuous line is the performed estimate.

It has to be noted that the algorithm contained in step 108 of the method according to the present invention such as shown in FIG. 1 carries out slight changes on the data available from the previous step 107 of the method according to the present invention such as shown in FIG. 1 (it is known that two opposite quaternions q*(tk) and −q*(tk) represent the same orientation of the triad of axes A*; therefore the algorithm contained in step 108 of the method according to the present invention such as shown in FIG. 1 suitably modifies the sign of the available data, in order to recover the whole attitude signal given by the quaternions with a continuous curve. With reference to FIG. 9, showing a graph of step 112 of the method according to the present invention such as shown in FIG. 1, it points out a first estimate of the absolute angular velocity of the body 2 orbiting in space expressed according to the inertial reference frame; particularly the abscissa shows time (unit of measure: seconds) while ordinate shows the three components of the angular velocity (unit of measure: radians/second) according to the inertial reference frame.

As it can be noted, the signal has a considerable noise overlapped on the “real” angular velocity signal.

With reference to FIG. 10, showing a graph of step 113 of the method according to the present invention such as shown in FIG. 1, it points out the final estimate of the angular velocity by algorithms filtering the data obtained from the previous step 112 of the method according to the present invention such as shown in FIG. 1.

The graph shows only the first component (component 1); the broken line is the “real” signal while the continuous line is the estimated signal.

Among the several and different applications of the method and system for measuring the angular velocity of a body orbiting in space according to the present invention, we desire to point out the measurement of the inertia tensor of a body orbiting in space; for measuring the inertia tensor, that requires as starting data the measurement of the angular velocity, it is possible to use the method and system disclosed here.

As deduced from what set forth above, the innovative technical solution described herein has the following advantageous characteristics:

it allows the angular velocity of a body in orbit to be accurately estimated without the need of measurements taken by instruments placed on board the body and without carrying out any actions intended to perturb the motion of the target;

it allows the measurement of the angular velocity of a body moving in space to be taken by only observing the motion of some points thereof;

it unifies the calculation method with the use of remote measurement devices;

the system, in particular the one according to the first embodiment, does not require complex and expensive arrangements with respect to traditional spacecraft;

it can be used for recovering and de-orbiting space debris and also for intercepting and then destroying or migrating asteroids, potentially colliding with Earth, into a controlled orbit.

From the description above therefore it is clear how the disclosed method and system allow the provided objects to be achieved.

It is also clear, for a person skilled in the art, that it is possible to make changes and variants to the solution described with reference to the annexed figures, without for this reason departing from the teaching of the present invention and from the scope of protection as defined by the annexed claims.

### CITATIONS

[1] E. J. Lefferts, F. L. Markley, M. D. Shuster. “Kalman Filtering for Spacecraft Attitude Estimation”, Journal of Guidance, Control, and Dynamics, Vol. 5, No. 5 (1982), pp. 417-429.

[2] Azor, Ruth, Y. Itzhack, I. Y. Bar-ltzhack. “Angular-Rate Estimation Using Quaternion Measurements.” J. of the Braz. Soc. Mechanical Sciences.-1999.-XXI-Special Issue (1998): 119-133.

[3] P. Singla, D. T. Griffith, J. L. Crassidis, J. L. Junkins. “Attitude determination and autonomous on-orbit calibration of star tracker for the gifts mission.” Advances in the Astronautical Sciences 112 (2002): 19-38.

[4] P. Singla, D. T. Griffith, J. L. Crassidis, J. L. Junkins. “Spacecraft angular rate estimation algorithms for star tracker-based attitude determination.” Advances in the Astronautical Sciences 114 (2003): 1303-1316.

[5] U.S. Patent application no. 2002/0117585—S. Yoshikawa, K. Yamada, H. Shimoji, M. Inoue, N. Yoshida, K. Miyatake. “Apparatus for determining attitude of artificial satellite”.

[6] U.S. Patent application no. 2004/0098177—D. Needelman, Y. Wu, R. Li. “Attitude acquisition method and spacecraft attitude acquisition and control system”.

[7] U.S. Patent application no. 2005/0071055—D. Needelman, Y. Wu, R. Li. “Refinement of spacecraft angular velocity and attitude estimates using star data”.

[8] U.S. Patent application no. 2011/007167—A. Katake, M. Jacox, J. Ochoa, C. Bruccaleri, J. Zbranek. “High-update rate estimation of attitude and angular rates of a spacecraft”.

[9] Chinese Patent application no. CN101706512 (2002)—X. Chen, Y. Geng, W. Lu. “Method for estimating pseudo rate of spacecraft based on attitude measurement information of star sensors and angular momentum measurement information of fly-wheels”.

[10] Joel A. Tropp.” Just relax: Convex programming methods for identifying sparse signals in noise.” Information Theory, IEEE Transactions on 52.3 (2006): 1030-1051.

[11] Manya V. Afonso, José M. Bioucas-Dias, Mário A. T. Figueiredo. “Fast image recovery using variable splitting and constrained optimization”, IEEE Transactions on Image Processing, v. 19 n. 9 (2010), p. 2345-2356

1. A method for measuring the angular velocity (\vec{ω}) of a body (2) orbiting in space, comprising the following steps:
n. preparing at least one remote sensor (1) (step 101);
o. defining a plurality (n) of feature points (Pi) to be observed of said body (2) orbiting in space (step 102);
p. acquiring, by the at least one remote sensor (1), data relevant to the positions taken over time (Pi(tk)) by the observed feature points (Pi) of said body (2) (step 103);
q. taking into account said plurality (n) of feature points (Pi), identifying
$$( \begin{matrix}n \\ 3\end{matrix} )$$
triads of said points (Pi), to which just as many triads (Aj) of axes correspond (step 104);
r. identifying a triad of axes (Aj(tk)) associated to the first three points (Pu(tk),Pv(tk),Pw(tk) with u≠v≠w) available for each k^{th} instant (step 105);
s. for each k^{th} instant, evaluating the quaternions (qj(tk)) describing the orientation of the triad (Aj(tk)), associated to the triad (Pu(tk),Pv(tk),Pw(tk)), with respect to an inertial reference frame (step 106);
t. selecting a particular triad of axes (A*) and evaluating the quaternions (q*(tk)) describing its orientation with respect to said inertial reference frame depending on the quaternions (qj(tk)) identified in the previous step 106 (step 107);
u. estimating the quaternions (q*(tk)) describing the orientation of the triad of axes (A*) in the instants when less than three of said points (Pi) are visible to determine the attitude over time of said body (2) (step 108);
v. generating a white noise (step 109);
w. overlapping said white noise to said estimation of the quaternions (q*(tk)) referred to in the previous step 108 (step 110);
x. estimating the derivative (\dot{q}*(tₖ)) of the quaternions (q*(tk)) using a Kalman filter (step 111);
y. evaluating a first estimate of the angular velocity (\vec{ω}) of said body (2) depending on the derivative (\dot{q}*(tₖ)) (step 112); and
z. finally evaluating the angular velocity (\vec{ω}) of said body (2) through a filtering algorithm (step 113).

2. A method according to claim 1, wherein said at least one remote sensor (1) is installed on board a spacecraft (3) in motion in an orbit close to that of said body (2).

3. A method according to claim 1, wherein said at least one remote sensor (1) is housed in a earth station (5).

4. A method according to claim 2, wherein the data acquired by said at least one remote sensor (1) are discontinuous due to the presence of non-visibility periods of at least one of said feature points (Pi) of said body (2).

5. A method according to claim 1, wherein the geometrical configuration of said body (2) is known and, preferably, the relative position of said feature points (Pi) to be observed of said body (2) is known.

6. A method according to claim 1, wherein the geometrical configuration of said body (2) is not known and the relative position of said feature points (Pi) to be observed of said body (2) is determined on the basis of the fact that, being known the coordinates of four different points in a time instant, their mutual positions, which are invariant, are determinable and of the fact that, when one of said feature points (Pi) is not visible in other time instants, its position can be identified by knowing that of said invariant mutual positions.

7. A method according to claim 1, wherein the filtering algorithm used for the final evaluation of the angular velocity (ii) of said body (2) according to step m. (step 113) is based on the Basis Pursuit Denoising methodology by solving a minimum search problem, preferably by applying the SALSA algorithm.

8. A system for measuring the angular velocity (\vec{ω}) of a body (2) orbiting in space, comprising:
at least one remote sensor (1) for the acquisition of the data relevant to the positions taken over time (Pi(tk)) by a plurality (n) of feature points (Pi) to be observed of said body (2);
taking into account said plurality (n) of feature points (Pi), first means for the identification of
$$( \begin{matrix}n \\ 3\end{matrix} )$$
triads of said points (Pi), which just as many triads (Aj) of axes correspond;
second means for the identification of a triad of axes (Aj(tk)) associated to the first three points (Pu(tk),Pv(tk),Pw(tk) with u≠v≠w) available for each k^{th} instant;
third means for the evaluation, for each k^{th} instant, of the quaternions (qj(tk)) describing the orientation of the triad (Aj(tk)), associated to the triad (Pu(tk),Pv(tk),Pw(tk)), with respect to an inertial reference frame;
fourth means for the selection of a particular triad of axes (A*) and the evaluation of the quaternions (q*(tk)) describing its orientation with respect to said inertial reference frame depending on said quaternions (qj (tk));
fifth means for the estimation of the quaternions (q*(tk)) describing the orientation of the triad of axes (A*) in the moments when less than three of said points (Pi) are visible to determine the attitude over time of said body (2);
sixth means for the generation of a white noise;
seventh means for the overlap of said white noise to said estimation of said quaternions (q*(tk));
eighth means for the estimation of the derivative (\dot{q}*(tₖ)) of the quaternions (q*(tk)) using a Kalman filter;
ninth means for the evaluation of a first estimate of the angular velocity (\vec{ω}) of said body (2) depending on the derivative (\dot{q}*(tₖ)); and
tenth means for the final evaluation of the angular velocity (\vec{ω}) of said body (2) through a filtering algorithm.

9. A system according to claim 8, wherein said at least one remote sensor (1) is installed on board a spacecraft (3).

10. A system according to claim 8, wherein said at least one remote sensor (1) is housed in an earth station (5).

11. A method according to claim 3, wherein the data acquired by said at least one remote sensor (1) are discontinuous due to the presence of non-visibility periods of at least one of said feature points (Pi) of said body (2).
